(19) United States
(12) Patent Application Publication
(10) Pub. No.: US 2005/0042959 A1
(43) Pub. Date: Feb. 24, 2005

(54) Anti-static fabric

(75) Inventors: Ya-Hui Yeh, Ping-Tung Hsien (TW); Cheng-Tao Wu, Kaohsiung City (TW)

Correspondence Address: WEBB ZIESENHEIM LOGSDON ORKIN & HANSON, P.C.;700 Koppers Building, 436 Seventh Avenue, Pittsburgh, PA, 15219-1818, US

(73) Assignee: HELIX TECHNOLOGY, INC.

(21) Appl. No.: 10/792,643

(22) Filed: Mar. 3, 2004

(30) Foreign Application Priority Data
Aug. 19, 2003 (TW) 092215007

(51) Int. Cl. B32B 15/14

(52) U.S. Cl. 442/110; 442/64; 442/65; 442/164

(57) ABSTRACT

An anti-static fabric includes a fabric substrate having a side face, and at least a thin metal film formed on the side face. The thin metal film has a volume resistivity ranging from 10 to 1×10⁸ ohm-cm, and a charge dissipating rate not greater than 0.1 second.

### CROSS-REFERENCE TO RELATED APPLICATION

This application claims priority of Taiwanese application No. 092215007, filed on Aug. 19, 2003.

### BACKGROUND OF THE INVENTION

1. Field of the Invention

This invention relates to an anti-static fabric, more particularly to an anti-static fabric having a fabric substrate and at least a thin metal film deposited on the fabric substrate.

2. Description of the Related Art

Anti-static fabrics can be used in the production of anti-static garments, anti-static carpets, anti-static conveying belts, anti-static packaging materials, anti-static curtains, and the like. The conventional anti-static fabrics can be classified into three basic categories: (1) anti-static fabrics which are formed by coating an anti-static agent-containing coating on a fabric substrate; (2) anti-static fabrics which are formed by spinning substrate fibers and anti-static filaments together; and (3) anti-static fabrics which are made from anti-static fibers that are formed by co-polymerization of a polymer material and an anti-static agent-containing material. The first category of the anti-static fabrics is disadvantageous in that manufacturing of the same may cause pollution and generates hazardous wastes and that their anti-static effects tend to degrade due to wearing of the coating. The second and third categories of the anti-static fabrics are disadvantageous in that flexibility and softness of the anti-static fabrics are significantly decreased and the fabric feel of the same is adversely affected.

### SUMMARY OF THE INVENTION

Therefore, the object of the present invention is to provide an anti-static fabric that is capable of overcoming the aforesaid drawbacks of the prior art.

According to the present invention, there is provided an anti-static fabric that includes: a fabric substrate having a side face; and at least a thin metal film formed on the side face. The thin metal film has a volume resistivity ranging from 10 to 1×10⁸ ohm-cm, and a charge dissipating rate not greater than 0.1 second.

### BRIEF DESCRIPTION OF THE DRAWINGS

In drawings which illustrate an embodiment of the invention,

FIG. 1 is a fragmentary sectional view of the preferred embodiment of an anti-static fabric according to the present invention; and

FIG. 2 is another fragmentary sectional view of the preferred embodiment.

### DETAILED DESCRIPTION OF THE PREFERRED EMBODIMENT

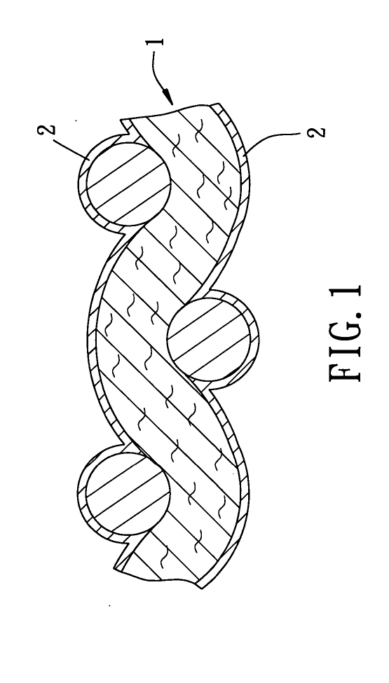

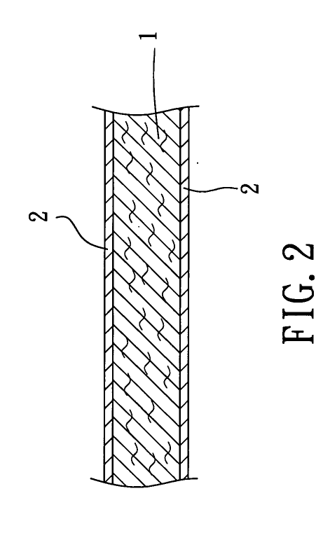

FIGS. 1 and 2 illustrate the preferred embodiment of an anti-static fabric according to the present invention.

The anti-static fabric includes: a fabric substrate 1 having two opposite side faces; and two thin metal films 2 formed respectively on the side faces of the fabric substrate 1. Each of the thin metal films 2 has a volume resistivity ranging from 10 to 1×10⁸ ohm-cm, and a charge dissipating rate not greater than 0.1 second. The volume resistivity of the anti-static fabric is controlled at a value greater than 10 ohm-cm so as prevent undesired electrical shock from taking place.

Preferably, each of the thin metal films 2 is deposited on the respective side face of the fabric substrate 1 by physical vapor deposition, and has a thickness ranging from 100 to 550 Å, which imparts the anti-static fabric with the requisite volume resistivity and charge dissipating rate without significantly affecting the flexibility, softness, and feel of the fabric.

Preferably, each of the thin metal films 2 is made from a metal that has a low activity and good adherence to fabric material and that is selected from the group consisting of nickel, nickel-chromium alloy, chromium, and titanium.

The fabric substrate 1 can be a woven (knitted or shuttled) or non-woven fabric. Preferably, the fabric substrate 1 is made from a plurality of synthetic fiber yarns having high tensile strength, high resistance to wearing, and high elastic modulus.

The present invention will now be described in greater detail with reference to the following Illustrative Examples 1 to 6.

Examples 1 to 6 used the same fabric material (a shuttled fabric) for the fabric substrate, but differ from each other in the metal selected for the thin metal film or in the thickness of the thin metal film. The volume resistivity and the charge dissipating rate were measured and calculated for Examples 1 to 6. The results are shown in Table 1.

TABLE 1

| | Thin | | Volume | Charge |
|---|---|---|---|---|
| Exam- | metal | | resistivity, | dissipating |
| ple | film | Thickness, Å | ohm-cm | rate, sec |
| 1 | Ni—Cr | 100 | 6.5 × 10⁷ | 0.1 |
| 2 | Ni—Cr | 450 | 20 | 0.01 |
| 3 | Cr | 100 | 6.0 × 10⁷ | 0.1 |
| 4 | Cr | 550 | 20 | 0.01 |
| 5 | Ti | 100 | 7.1 × 10⁷ | 0.1 |
| 6 | Ti | 500 | 250 | 0.01 |

The results show that, by controlling the thickness of the thin metal film within the aforesaid thickness range and by selecting a suitable metal for the thin metal film, the aforesaid drawbacks associated with the prior art can be eliminated.

With the invention thus explained, it is apparent that various modifications and variations can be made without departing from the spirit of the present invention.

1. An anti-static fabric comprising:
a fabric substrate having a side face; and
at least a thin metal film formed on said side face of said fabric substrate;
wherein said thin metal film has a volume resistivity ranging from 10 to 1×10⁸ ohm-cm, and a charge dissipating rate not greater than 0.1 second.

2. The anti-static fabric of claim 1, wherein said thin metal film is deposited on said side face of said fabric substrate by physical vapor deposition.

3. The anti-static fabric of claim 1, wherein said thin metal film has a thickness ranging from 100 to 550 Å.

4. The anti-static fabric of claim 2, wherein said thin metal film has a thickness ranging from 100 to 550 Å.

5. The anti-static fabric of claim 1, wherein said thin metal film is made from a metal selected from the group consisting of nickel, nickel-chromium alloy, chromium, and titanium.

6. The anti-static fabric of claim 4, wherein said thin metal film is made from a metal selected from the group consisting of nickel, nickel-chromium alloy, chromium, and titanium.

7. The anti-static fabric of claim 1, wherein said fabric substrate is made from a plurality of synthetic fiber yarns.

8. An anti-static fabric comprising:
a fabric substrate having two opposite side faces; and
two thin metal films formed respectively on said side faces of said fabric substrate;
wherein each of said thin metal films has a volume resistivity ranging from 10 to 1×10⁸ ohm-cm, and a charge dissipating rate not greater than 0.1 second.

9. The anti-static fabric of claim 8, wherein each of said thin metal films has a thickness ranging from 100 to 550 Å.

10. The anti-static fabric of claim 9, wherein each of said thin metal films is made from a metal selected from the group consisting of nickel, nickel-chromium alloy, chromium, and titanium.
